(19) United States
(12) Patent Application Publication
(10) Pub. No.: US 2026/0070761 A1
(43) Pub. Date: Mar. 12, 2026

(54) ARRANGEMENT CONSISTING OF A CRAWLER CRANE AND A COUNTERWEIGHT CARRIAGE AND METHOD FOR OPERATING SAME

(71) Applicant: Tadano Demag GmbH, Zweibrücken (DE)

(72) Inventors: Fritz-Botho Köster, Rockenhausen (DE); Steffen Kickhefel, Saarbrücken (DE)

(21) Appl. No.: 19/324,581

(22) Filed: Sep. 10, 2025

(30) Foreign Application Priority Data
Sep. 11, 2024 (DE) 102024126152.8

(51) Int. Cl. B66C 23/76; B66C 13/18

(52) U.S. Cl. CPC B66C 23/76; B66C 13/18

(57) ABSTRACT

An arrangement and method of operating a crawler crane and a counterweight carriage for an additional counterweight, where the additional counterweight is connected to a superstructure of the crawler crane via a coupling unit. The coupling unit consists of a connecting frame and a coupling frame, where the connecting frame is fastened on the support device, and the coupling frame is fastened at one end to the superstructure and is fastened at the other rear end to the connecting frame. The connecting frame has a substantially vertical first axis of rotation.

### CROSS REFERENCE TO RELATED APPLICATION

The present application claims the priority benefits of German patent application no. 102024126152.8, filed on Sep. 11, 2024.

### BACKGROUND AND FIELD OF THE INVENTION

The invention relates to an arrangement consisting of a crawler crane and a counterweight carriage for an additional counterweight, wherein the additional counterweight is connected to a superstructure of the crawler crane via a coupling unit. The invention also relates to a method for operating an arrangement consisting of a crawler crane and a counterweight carriage for an additional counterweight, wherein the crawler crane has a crane controller and the counterweight carriage has a counterweight carriage controller.

German utility model document DE 20 2009 011 577 U1 discloses a crawler crane having a movable lower carriage with crawler tracks and a superstructure which is arranged on the lower carriage so as to be pivotable about a vertical axis. A jib which can be luffed about a horizontal axis and a derrick jib or counter jib which can be luffed about a horizontal axis are mounted on the superstructure. The superstructure supports a counterweight and an additional counterweight is suspended from a tip of the counter jib. In order to be able to move or rotate the crawler crane with the additional counterweight when the crawler crane is unloaded, the additional counterweight is placed on a movable counterweight carriage. The counterweight carriage is connected to the superstructure via a lattice mast-type coupling unit and is designed as a standard heavy-duty transport vehicle. The coupling unit is dimensioned such that all transverse forces which occur are absorbed by the coupling unit because the counter jib is not designed to absorb transverse forces.

The heavy-duty transport vehicles used as counterweight carriages are generally known and have been a proven means of transporting large loads, such as e.g. bridge elements or parts of drilling rigs, for decades. Basically, a heavy-duty transport vehicle consists of a transport platform and a large number of steerable wheels, at least some of which are driven by an independent drive unit of the heavy-duty transport vehicle. Therefore, the heavy-duty transport vehicle can be moved in any movement directions. The heavy-duty transport vehicle is controlled by manual input of control commands into a user interface which is part of an operating unit of the heavy-duty transport vehicle. Such heavy-duty transport vehicles have a dedicated drive controller which can be equipped with steering programmes which assist the driver e.g. when driving straight ahead, sideways, diagonally, around corners or turning on the spot. Several heavy-duty transport vehicles can be coupled together and moved together so as to accommodate a load which is to be transported.

In contrast to the standard heavy-duty transport vehicles which, via a dedicated drive and control unit, can be moved and controlled independently and can be used for transport tasks of any kind, counterweight carriages can also be part of a crawler crane. Accordingly, these crawler crane counterweight carriages are individually adapted to the respective crawler crane and predominantly use energy and control signals from the crawler crane.

The subsequently published European patent specification EP 4 461 693 A1 discloses various embodiments of a crawler crane which is connected by means of a guide to a ballast carriage which is designed as a heavy-duty transport device and has a ballast weight. Its crane controller is connected via a control connection to a drive controller of the heavy-duty transport device which is controlled or regulated by the crane controller in dependence upon a force detected by a measuring device. The guide which connects the crawler crane and the heavy-duty transport device is designed as a lattice mast structure. In one embodiment, a rotating assembly and a sliding carriage, which allow a movement of the ballast plate relative to the guide, are provided between the guide and the ballast weight which rests on the heavy-duty transport device.

The further European patent specification EP 3 925 924 A1 discloses a crawler crane which is connected to a self-driving ballast carriage by means of a connecting beam. In this case, the connecting beam comprises a connecting tube body having connecting portions and a slide. The connecting tube body is fastened to a superstructure of the crawler crane by means of the connecting portions, wherein, in accordance with the movement of the self-driving ballast carriage, the slide can rotate on the one hand about a rotational center axis, which extends in a vertical direction, relative to the ballast carriage and on the other hand is movable in a longitudinal direction relative to the connecting portions.

According to German utility model DE 20 2009 011 577 U1, the drive controller of the heavy-duty transport vehicle is influenced as a result of the movement of the crawler crane. The basic movements of the crawler crane consist, on the one hand, of rotating the superstructure and, on the other hand, of towing where the heavy-duty transport vehicle follows behind the crawler crane. In one embodiment, the heavy-duty transport vehicle has an additional controller which automatically determines a corresponding steering center when the crawler crane is being rotated, and automatically generates steering, acceleration and/or deceleration commands during towing. In another embodiment without an automatically operating additional controller, it is to be ensured that the heavy-duty transport vehicle and the crawler crane are stopped in the event that a steering error on the heavy-duty transport vehicle results in an undesired application of force to the coupling unit. For this purpose, signals from sensors in the region of the coupling unit are evaluated. After stopping, the heavy-duty transport vehicle can be moved to a desired position by means of manual control, and the crawler crane can then resume its operation.

Furthermore, German laid-open document DE 10 2006 010 488 A1 discloses a further modular counterweight carriage for large cranes. The counterweight carriage is connected to a superstructure of the large crane via a connecting rod. The counterweight is divided up into a counterweight which is movable by the counterweight carriage, and counterweight which is not movable. The movable counterweight is placed in the form of several stacks of weight plates on a platform of the counterweight carriage. The non-movable counterweight is also placed in the form of several stacks of weight plates on a pallet. During operation, the movable counterweight and the non-movable counterweight are suspended from the large crane via a cross-piece. For this purpose, chains are arranged between the platform of the counterweight carriage and the cross-piece, and rods are arranged between the cross-piece and the pallets of the non-movable counterweights.

### SUMMARY OF THE INVENTION

The present invention provides an improved arrangement consisting of a crawler crane and a counterweight carriage for an additional counterweight and a method for operating such an arrangement.

In accordance with an embodiment of the invention, in the case of an arrangement consisting of a crawler crane and a counterweight carriage for an additional counterweight, wherein the additional counterweight is connected to a superstructure of the crawler crane via a coupling unit, wherein the coupling unit has a connecting frame and a coupling frame, the connecting frame is fastened on a support device of the additional counterweight, the coupling frame is fastened at one end to the superstructure and is fastened at another rear end to the connecting frame, and where the connecting frame has a substantially vertical first axis of rotation, about which the coupling frame is pivotable.

In connection with the present disclosure, counterweight carriages are understood to be, on the one hand, the crawler crane counterweight carriages individually adapted to the respective crawler crane by a crane manufacturer and, on the other hand, the standard heavy-duty transport vehicles which can be moved and controlled independently via a dedicated drive and control unit and are to be used for transport tasks of any kind. The crawler crane counterweight carriages use predominantly energy and control signals from the crawler crane and are part of the crawler crane.

In a particular embodiment, provision is made that the counterweight carriage consists of at least one standard heavy-duty transport vehicle. In the event that a crane operator already has heavy-duty transport vehicles available for other transport tasks there is no need to acquire a crawler crane counterweight carriage.

From a structurally advantageous point of view, provision is made that the additional counterweight consists of a support device and additional counterweight plates stacked thereon and the coupling unit is fastened directly to the support device.

From a further structurally advantageous point of view, provision is made that the coupling unit consists of a connecting frame and a coupling frame, the connecting frame is fastened on the support device, the coupling frame is fastened at one end to the superstructure and is fastened at the other rear end to the connecting frame. For this purpose, corresponding joints are arranged in the connecting frame, and the connecting frame is connected overall in an articulated manner to the support device or is mounted on the support device.

The arrangement is characterised by the fact that the connecting frame has a substantially vertical first axis of rotation, about which the coupling frame can be pivoted in particular in one direction of rotation and in an opposite direction thereto. The first axis of rotation extends vertically in an upwards direction and on flat, horizontal area.

In the event that the counterweight carriage advances ahead or lags behind in relation to the crane, the coupling frame can also pivot about the axis of rotation in the Z direction. A changing angle of rotation can be detected by means of a first sensor. The detected sensor signal enables control or regulation of the counterweight carriage and so the advance or the lag is reduced or even avoided and the counterweight carriage moves as synchronously as possible with respect to the crane.

The connecting frame is preferably provided to connect the coupling frame of the coupling unit in an articulated manner to the additional counterweight, in particular the support device. For this purpose, it can have a first transverse axis, a second transverse axis collinear thereto and a substantially parallel third transverse axis, as well as an axis of rotation. The second transverse axis extends preferably in a longitudinal direction of the counterweight carriage. By reason of their collinear or parallel arrangement with respect to the second transverse axis, the first and third transverse axes likewise extend preferably in the longitudinal direction of the counterweight carriage. In this case, during circular travel of the arrangement the longitudinal direction of the counterweight carriage is arranged preferably transversely to the longitudinal direction of the crane. In a flat, horizontal area, the transverse axes are also oriented horizontally.

The connecting frame thus enables all relative movements between the coupling frame and the additional counterweight, in particular the support device of the additional counterweight, which are required during travel of the arrangement consisting of the crane and counterweight carriage. In a first embodiment, this enables a rigid connection of the coupling frame to the connecting frame, in particular to a component of the connecting frame, and, in a second embodiment, enables a connection of the coupling frame to the connecting frame which is rigid in the X direction and Y direction and is articulated in the Z direction, in particular to a component of the connecting frame. By detecting the relative movements in the connecting frame, in particular about the axes of the connecting frame, it is thus possible to deduce the relative movements between the crane and the counterweight carriage, in particular advancing ahead, lagging behind and/or a change in the distance between the counterweight carriage and the crane. By reason of the detected relative movements in the connecting frame, the counterweight carriage can thus be controlled or regulated as synchronously as possible with respect to the crane.

It is preferred that the coupling frame is mounted, preferably directly, on the connecting frame so as to be pivotable about the second transverse axis and, in a second embodiment, rotatable about the first axis of rotation. Preferably, it is pivotable about the second transverse axis in a second pivoting direction and in an opposite direction thereto, and is rotatable about the first axis of rotation in a first direction of rotation and in an opposite direction thereto.

For this purpose, the connecting frame preferably has a pivoting element which is mounted so as to be pivotable about the second transverse axis, wherein the coupling frame is mounted on the pivoting element. As a result, the coupling frame can be pivoted together with the pivoting element about the second transverse axis.

More preferably, the connecting frame has a bearing element. The bearing element can be arranged on or in the pivoting element. Preferably, the bearing element provides the vertical first axis of rotation. In the second embodiment, the coupling frame is fastened preferably to the bearing element. It can be fastened rigidly to the bearing element, e.g. by screwing. As a result, the coupling frame can be pivoted together with the bearing element about the vertical first axis of rotation. Alternatively, the coupling frame rotates about the bearing element.

The coupling frame has a longitudinal extension and is preferably designed to be surface-symmetrical relative to its longitudinal extension. When the coupling frame is in a mounted state on the arrangement consisting of the crane and the counterweight carriage arranged transversely to the crane, the longitudinal extension extends in the transverse direction of the counterweight carriage. A transverse direction of the coupling frame is oriented transversely to its longitudinal extension.

In a particularly preferred manner, the coupling frame has a bearing position which is located at is rear end. In an especially preferred manner, it has precisely one bearing position which is located centrally at its rear end, in particular in the transverse direction of the coupling frame. It is also particularly preferred that the bearing element is arranged centrally on the pivoting element. Furthermore, it is particularly preferred that the connecting frame is also designed to be surface-symmetrical, in particular with respect to its first axis of rotation. In an especially preferred embodiment, when the coupling frame is fastened to the connecting frame, it is therefore fastened at its precisely one bearing position to the bearing element arranged in the center of the pivoting element and, by reason of the symmetry of the arrangement, is pivoted equally in the direction of rotation or in the opposite direction thereto about the first axis of rotation of the connecting frame when the counterweight carriage advances ahead or lags behind in relation to the crane. This embodiment can be implemented with few components and therefore little outlay.

In a preferred embodiment, a rear end of the coupling frame is suspended via the second transverse axis, in particular in a swinging manner, via the pivoting element in the connecting frame, wherein the pivoting element can be pivoted about the first axis of rotation within the connecting frame. The rear end of the coupling frame can be attached to the connecting frame quickly and easily.

The connecting frame has preferably two mutually opposite connection rods which delimit the connecting frame laterally, wherein an outer frame is arranged between the two connection rods and is rigidly fastened thereto. Forces acting from the coupling frame onto the connecting frame are introduced into the connection rods. The outer frame thereby provides the connecting frame with sufficient stability. This can reduce or even prevent uncontrolled twisting of the connection rods about a vertical axis, as caused by reason of forces during the operation of the arrangement consisting of the crane and counterweight carriage.

In a preferred embodiment, the connection rods are angularly movable in a synchronous manner with respect to one another in each case about a second transverse axis relative to the support device. This enables a length compensation of the coupling unit transversely to the longitudinal direction of the counterweight carriage, in particular an at least slight length compensation.

For this purpose, it is further preferred that the connecting frame comprises bearing components which are fastened to the support body in a positionally fixed manner, wherein each of the connection rods is mounted on a respective one of the bearing components so as to be pivotable about a third transverse axis. Since the connection rods are rigidly fastened to one another via the outer frame, they are pivoted about the third transverse axis, in particular in a third pivoting direction and in an opposite direction thereto.

The angular mobility of the connection rods is delimited preferably in both directions in each case via a stop which is supported on the support device when the respectively maximum angle is reached. Contact of the stop on the support device, which is effected when the respectively maximum angle is reached, can be detected by sensors and taken into account in the crane controller and/or can be displayed to an operator as a warning. In particular, the arrangement consisting of the crane and counterweight carriage can be stopped when the maximum angle is reached.

The pivoting element extends preferably between the two connection rods. It is arranged preferably within or above the outer frame. In principle, however, it can also be arranged laterally or below the outer frame. The arrangement above the outer frame has proven to be advantageous because the connecting frame can thus be produced with few components and the coupling frame can be attached to the connecting frame easily, in particular from above.

Preferably, the coupling frame is attached to the connecting frame by virtue of the fact that, in a second embodiment, a rear end of the coupling frame is fastened to a bolt-like bearing element in a detachable and preferably direct manner. This can be done very quickly using a commercially available tool. In the embodiment with precisely one bearing position of the coupling frame, the coupling frame can be fastened to the connecting frame e.g. by means of a bolt or a screw. In a first embodiment, the fastening is effected indirectly via a pivoting element on a frame-like bearing element.

In a preferred embodiment, additional guying arrangements are bolted in an articulated manner to the connecting frame in each case via the first transverse axes at an upper end of the two connection rods. This enables the additional counterweight to be raised, in particular even without the counterweight carriage. The additional guying arrangements extend preferably in each case from a counter jib head of a counter jib of the crane to the connection rods. By virtue of the fact that the coupling frame is connected directly to the counter jib via the additional guying arrangements and connection rods, the relative movements in the connecting frame have no influence on the counterweight radius. Moreover, the certainty and accuracy of bearing load determination is improved.

Preferably, the connecting frame is fastened on the one hand to the coupling frame and on the other hand to the support device with at least some degree of translational freedom and some degree of rotational freedom. The at least some degree of translational freedom is provided by the second and third transverse axis, and the degree of rotational freedom is provided by the first axis of rotation. By virtue of the fact that the connecting frame is fastened on the one hand to the coupling frame and on the other hand to the support device with at least some degree of translational freedom and at least some degree of rotational freedom, relative movements between the crawler crane and the counterweight carriage can be enabled and detected. These degrees of freedom prevent damage to the coupling unit because e.g. the slip under the tracks of the crawler crane and the tires of the counterweight carriage can be different.

In an advantageous manner, provision is made that at least a first sensor and a second sensor are arranged on the connecting frame, wherein the first sensor ascertains the rotations about the first axis of rotation and the second sensor ascertains rotations about the third transverse axis. In a preferred manner, the first sensor is used for detecting an angle of rotation of the counterweight carriage relative to the superstructure about the vertical first axis of rotation. Also in a preferred manner, the second sensor is used for detecting a movement of the counterweight carriage and the additional counterweight resting thereon, with the length of coupling unit being invariable relative to the superstructure and in the longitudinal direction of the superstructure. For this purpose, the first and second sensors are preferably designed in each case as angle sensors. These sensor signals are used to verify and correct a control of the counterweight carriage. This achieves a further improvement in that the connecting frame in accordance with the invention directly permits relative movements and no bracing forces are permitted. The relative movements are detected by the sensors and are reduced to minimal relative movements in the connecting frame via the crane controller.

The coupling frame can be continuously varied in length in order to be able to vary the effective radius of the additional counterweight. The coupling frame can also be designed to be rigid or invariable in length.

In a structurally advantageous manner, provision is made that the crawler crane has a counter jib, from which the additional counterweight is suspended.

In a particularly advantageous embodiment a crane controller of the crawler crane controls the counterweight carriage via its counterweight carriage controller. The counterweight carriage which is designed as a heavy-duty transport vehicle can thus be controlled directly from the crane controller via an interface. Manual control of the counterweight carriage can be omitted. The crane controller evaluates signals from the first sensor and the second sensor for the purpose of verifying and, if necessary, correcting the control.

In a typical manner, provision is made that the counterweight carriage has a dedicated drive, a dedicated steering system and a dedicated counterweight carriage controller.

In a method for operating an arrangement consisting of a crawler crane and a counterweight carriage for an additional counterweight, in particular a previously described arrangement, wherein the crawler crane has a crane controller and the counterweight carriage has a counterweight carriage controller, an improvement is achieved in that the counterweight carriage is controlled by the crane controller of the crawler crane via its counterweight carriage controller. The counterweight carriage which is designed as a heavy-duty transport vehicle can thus be controlled directly from the crane controller via an interface. Manual control of the counterweight carriage can be omitted. Manual control or tracking of the counterweight carriage very quickly results in high constraint forces in the coupling unit and so a monitoring system is to be installed. The crane movement of “circular travel” and “towing travel” can thus be reliably controlled and the operation of the counterweight carriages is automated and is thus easier than manual operation.

In accordance with an embodiment of the invention, provision is made that signals from at least a first sensor and a second sensor are evaluated by the crane controller in order to verify and correct the control of the counterweight carriage. Preferably in this case, the first sensor is arranged in the region of the first axis of rotation on the connecting frame and the second sensor is arranged in the region of the third transverse axis on the connecting frame.

In a preferred manner, the method makes provision for the first sensor to be used for detecting an angle of rotation of the counterweight carriage relative to the superstructure about the vertical first axis of rotation. Also in a preferred manner, the method makes provision for the second sensor to be used for detecting a movement of the counterweight carriage with the additional counterweight resting thereon, with the length of coupling unit being invariable relative to the superstructure and in the longitudinal direction of the superstructure. The detected sensor signals enable reliable control of the arrangement, in particular so that the driving movements of the crane and the counterweight carriage take place in the most synchronous manner possible with respect to one another.

An advantage of the present disclosure is also that of using mass-produced heavy-duty transport vehicles as counterweight carriages for crawler cranes with an additional counterweight or superlift counterweight. Furthermore, the heavy-duty transport vehicles can also be used with various types of crawler cranes.

Overall, the present invention is also characterised by the fact that the connecting frame has several degrees of freedom which enable relative movements. The connecting frame has a plurality of sensors which sense relative movements, with which the crane controller can calculate specific parameters in order to communicate them to the counterweight carriage controller so that it can drive the counterweight carriage as close as possible to a desired position. The coupling frame is connected directly to the counter jib via the additional guying arrangement and the connection rods. As a result, the relative movements in the connecting frame have no influence on the counterweight radius. It is thus possible to achieve counterweight radii which are less than or greater than the counter jib radius. Moreover, the certainty and accuracy of bearing load determination is improved.

Two exemplified embodiments of the invention will be explained in greater detail with reference to the following description.

### BRIEF DESCRIPTION OF THE DRAWINGS

FIG. 1 shows a side view of an inventive arrangement consisting of a crawler crane and a counterweight carriage in a first embodiment;

FIG. 2 shows an enlarged side view of the counterweight carriage shown in FIG. 1;

FIG. 3 shows an enlarged front view of the counterweight carriage shown in FIG. 1 without additional counterweight plates;

FIG. 4 shows a perspective enlargement of a section of FIG. 2 from the region of the connecting frame of the coupling unit;

FIG. 5 shows a schematic overview for controlling the counterweight carriage;

FIG. 6 shows a side view of a further inventive arrangement consisting of an alternative crawler crane and a counterweight carriage;

FIG. 7 shows a side view of an inventive arrangement consisting of a crawler crane and a counterweight carriage in a second embodiment;

FIG. 8 shows a side view of the counterweight carriage of FIG. 7;

FIG. 9 shows a plan view of the counterweight carriage of FIG. 7;

FIG. 10 shows an enlargement of a section of FIG. 8 from the region of the connecting frame of the coupling unit;

FIG. 11 shows a plan view of a section of the coupling unit;

FIG. 12 shows a front view of the counterweight carriage of FIG. 8; and

FIG. 13 shows a perspective view of a section of the counterweight carriage 2 of FIG. 8.

### DESCRIPTION OF THE PREFERRED EMBODIMENTS

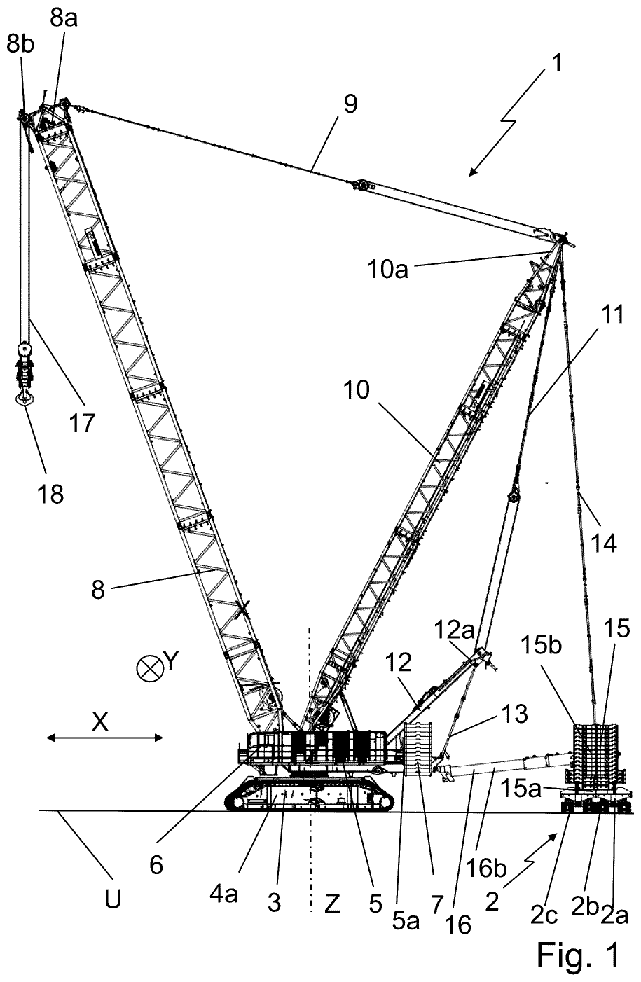

FIG. 1 shows a side view of an inventive arrangement consisting of a crawler crane 1 and a counterweight carriage 2 in a first embodiment. In a conventional manner, the crawler crane 1 has a lower carriage 3 having two right and left crawler tracks 4a, 4b which are arranged in parallel with one another and can be moved on a ground U. The crawler tracks 4a, 4b extend in parallel with a substantially horizontally extending longitudinal direction X of the lower carriage 3 and are spaced apart from one another in a transverse direction Y which extends orthogonally to the longitudinal direction X and substantially horizontally. The longitudinal direction X of the lower carriage 3 corresponds to a straight-ahead direction of travel of the lower carriage 3 or of the crawler crane 1. Naturally, by reason of the side view chosen in this case, only the left crawler track 4a can be seen, while the right crawler track 4b is concealed by the lower carriage 3. Arranged on the lower carriage 3 is a superstructure 5 which can be pivoted relative to the lower carriage 3 about a vertically extending axis of rotation Z. The superstructure 5 is provided with a driver's cabin 6 at the front on one side and with a counterweight 7 at its opposite rear end 5a. A jib 8, in particular a main jib, in the form of a lattice mast jib is articulated to the superstructure 5 and can be luffed about a horizontal luffing axis which extends in parallel with the transverse direction of the superstructure 5. The jib 8 is luffed via hoist-type luffing cabling 9 which is tensioned between a jib head 8a of the jib 8 and a counter jib head 10a of a counter jib 10 or derrick jib. Like the jib 8, the counter jib 10 is fastened to the superstructure 5 about a horizontal axis extending in parallel with the transverse direction of the superstructure 5 and is fastened to a guying support 12 in a conventional manner starting from the counter jib head 10a via a counter jib guying arrangement 11. The counter jib guying arrangement 11 is also designed as luffing cabling. The guying support 12, also referred to as an A-frame, is fastened to the superstructure 5 in an articulated manner via a horizontal axis extending in parallel with the transverse direction of the superstructure 5. A guying support-guying arrangement 13 which is fastened to a rear end 5a of the superstructure 5 engages in the region of a guying support head 12a. In addition, an additional counterweight 15 is suspended from the counter jib head 10a of the counter jib 10 via an additional guying arrangement 14 and is supported via a coupling unit 16 at the rear end 5a of the superstructure 5. For this purpose, the coupling unit 16 is fastened on the one hand to the superstructure 5 and on the other hand to the additional counterweight 15. In addition, the coupling unit 16 can be variable in length or can be telescopic in order to be able to set an effective counterweight moment of the additional counterweight 15 by setting a radius of the additional counterweight 15 in relation to the axis of rotation Z of the superstructure 5. This additional counterweight 15 is frequently also referred to as a superlift weight.

The luffing cabling 9 described above, the counter jib guying arrangement 11, the guying support-guying arrangement 13 and the additional guying arrangement 14 each consist of cables, chains or rods, as well as portions thereof arranged one behind the other or any combinations thereof. Hoist-type tensioning devices can also be provided at this location.

Arranged at a front free end of the jib head 8a of the jib 8 are deflection pulleys 8b of an upper block, over which a lifting cable 17 is guided to a hook 18 with a lower block in order to raise and move and then lower and set down a load which can be coupled to the hook 18.

FIG. 1 shows the crawler crane 1 in an unloaded state, i.e. no load is suspended from hook 18. In order, in this unloaded state, to be able to move or rotate the crawler crane 1 also with the additional counterweight 15, the additional counterweight 15 is placed on a movable counterweight carriage 2. In FIG. 1, the counterweight carriage 2 extends with its longitudinal extension substantially in the transverse direction Y and is thus oriented orthogonally to the longitudinal direction X-straight-ahead direction of travel of the lower carriage 3 or of the crawler crane 1. The additional counterweight 15 is connected to the superstructure 5 via the coupling unit 16. The coupling unit 16 can also be referred to as a coupling device, coupling system or coupling arrangement because it consists of a large number of components. The coupling unit 16 can be telescopic or variable in length or can have a fixed length. The additional counterweight 15 consists substantially of a lower pallet-like support device 15a and additional counterweight plates 15b which are stacked on the support device 15a in one or more stacks. The counterweight carriage 2 is designed as a standard heavy-duty transport vehicle.

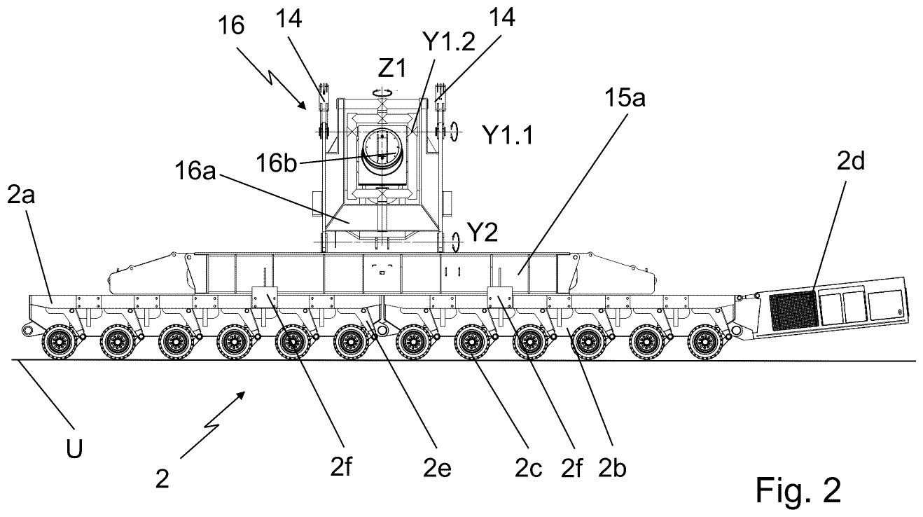

FIG. 2 shows an enlarged side view of the counterweight carriage 2 shown in FIG. 1. The support device 15a which is part of the additional counterweight 15 is placed on a transport platform 2a of the counterweight carriage 2. The additional counterweight plates 15b which are stacked in a conventional manner on the support device 15a are not illustrated. The support device 15 is designed in the form of a pallet or frame and supports, in the center, a connecting frame 16a which is part of the coupling unit 16. The connecting frame 16a has the task of connecting a coupling frame 16b of the coupling unit 16 in an articulated manner to the support device 15a or the additional counterweight 15. For this purpose, the connecting frame 16a has a first transverse axis Y1.1, a second transverse axis Y1.2 which is collinear thereto, a substantially parallel third transverse axis Y2 and a first substantially vertical axis of rotation Z1. In addition, the connecting frame 16a serves, at its lateral upper end, to couple the two additional guying arrangements 14 in an articulated manner via the two first transverse axes Y1.1. The additional guying arrangements 14 come from the counter jib head 10a. The coupling frame 16b is preferably designed as a tube which, in a particularly preferred manner, is telescopic. The coupling frame 16b can also be designed as a lattice mast structure or as a box girder. Combinations of the tube, lattice mast structure or box girder are feasible.

The counterweight carriage 2 is designed as a standard, self-driving heavy-duty transport vehicle which is generally known and has proven to be successful in the transport of heavy loads for decades. These heavy-duty transport vehicles have a dedicated drive and control unit and therefore can be moved and controlled independently. The counterweight carriage 2 consists substantially of the transport platform 2a which rests on a running gear unit frame 2b, on which a large number of wheels 2c are mounted on center pivot plates 2e so as to be pivotable about a vertical axis. Two center pivot plates 2e are provided per axle. The center pivot plates 2e with the wheels 2c can each be steered individually and the wheels 2c on at least a part of the center pivot plates 2e are driven individually. The counterweight carriage 2 also has a drive and control module 2d which, in extension of the transport platform 2a, is fastened to the running gear unit frame 2b in extension of the counterweight carriage 2. The counterweight carriage 2 can be moved in any movement directions on the ground U.

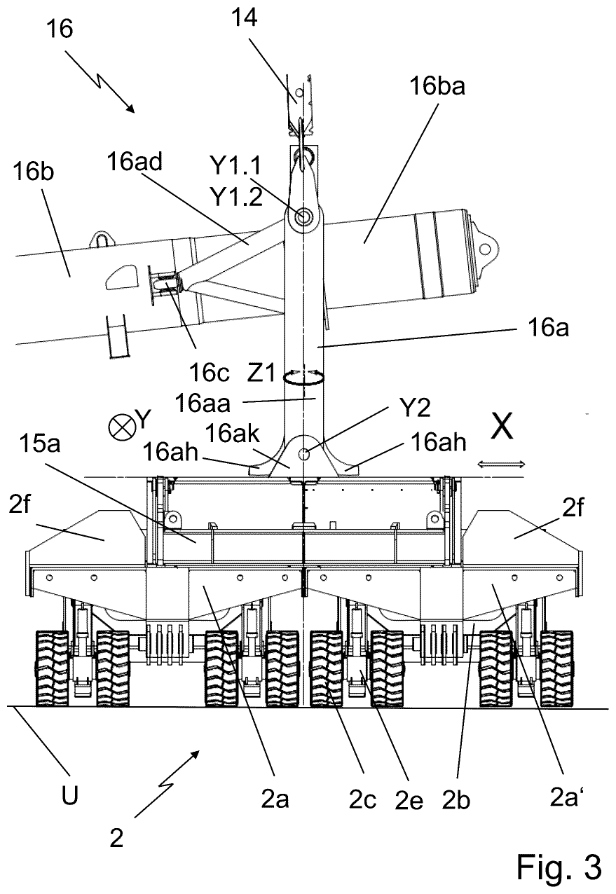

FIG. 2 illustrates the counterweight carriage 2 with its wheels 2c in circular travel, i.e. all wheels 2c move on a circular path determined by the distance of the wheels 2c from the pivot axis of the superstructure 5. However, the respective steering angle of the wheels 2c is so small that it is hardly noticeable in FIG. 2 which shows a side view of the wheels 2c. The counterweight carriage 2 is thus almost always oriented with its longitudinal direction at a right angle to the longitudinal direction of the superstructure 5. The counterweight carriage 2 is controlled via its drive and control module 2d which receives corresponding control signals from a crane controller of the crawler crane 1. In the present case, in adaptation to the dimensions and the weight of an additional counterweight 15 which is to be transported, a total of four standard heavy-duty transport vehicles has been coupled to one another mechanically and in terms of control technology to form a counterweight carriage 2 (see also FIG. 3) and are moved together in master and slave mode. Each of these four heavy-duty transport vehicles has six axles which are arranged one behind the other as seen in the longitudinal direction of the counterweight carriage 2. Each axle is allocated two center pivot plates 2e, on which two wheels 2c are mounted in each case. Therefore, each heavy-duty transport vehicle has 24 wheels in total. The wheels 2c of each axle can also be steered individually but the wheels 2c of only every second axle are driven. The number of driven axles can be adapted to the load which is to be transported, or to other boundary conditions.

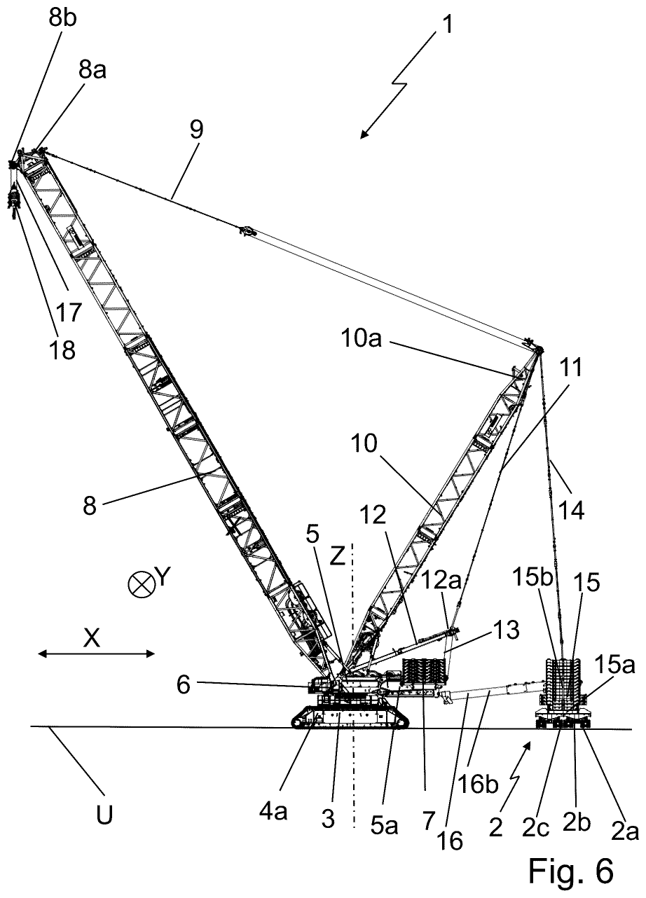

FIG. 3 shows an enlarged front view of the counterweight carriage 2 shown in FIG. 1. For reasons of clarity and in order to show the coupling unit 16 with connecting frame 16a and a rear part of coupling frame 16b more clearly, no stacked additional counterweight plates 15b (see FIGS. 1 and 6) are shown on support device 15a. It is apparent from this front view shown in FIG. 3 that the counterweight carriage 2 is formed from two heavy-duty transport vehicles which are coupled mechanically and in terms of control technology next to one another in the region of the two transport platforms 2a, 2a′. For clarification purposes, the transport platform 2a located on the right is designated as 2a′ in FIG. 3. The further two heavy-duty transport vehicles which are coupled one behind another mechanically and in terms of control technology are shown in FIG. 2. In relation to a longitudinal direction of the two heavy-duty transport vehicles, the heavy-duty transport vehicles are arranged in parallel with one another and with their transport platforms 2a, 2a′ adjacent to one another. The support device 15a thus rests simultaneously on four transport platforms 2a, 2a′ of the coupled heavy-duty transport vehicles. The support device 15a is not fastened, in particular not mechanically, to the two transport platforms 2a, 2a′, but instead rests only with its dead weight on the transport platforms 2a, 2a′. In order to facilitate positioning of the support device 15a of the additional counterweight 15 on the transport platforms 2a, 2a′ and to prevent the additional counterweight 15 from slipping in the horizontal transverse direction of the counterweight carriage 2 on the transport platforms 2a, 2a′ or in the longitudinal direction of the crawler crane 1, upwardly protruding guides 2f are arranged on the transport platforms 2a, 2a′. Further guides 2f can also be provided which prevent the additional counterweight from slipping in the horizontal longitudinal direction of the counterweight carriage 2 on the transport platforms 2a, 2a′. In principle, it is also feasible to bolt the additional counterweight 15 to the transport platforms 2a, 2a′ or their guides 2f and therefore additionally to use at least some of the weight of the transport platforms 2a, 2a′ as an additional counterweight 15. The additional counterweight 15 is then detachably coupled to the transport platforms 2a, 2a′.

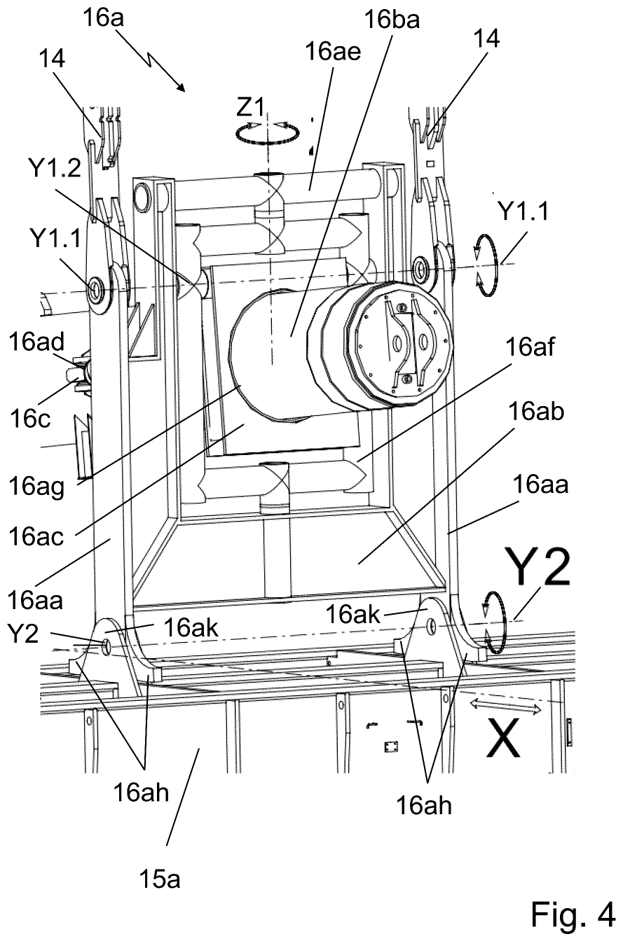

The connecting frame 16a is designed as a universal joint frame which has a large number of components described below and has degrees of rotational freedom and, by extension, also degrees of translational freedom (second transverse axis Y1.2, third transverse axis Y2, first axis of rotation Z1). The connecting frame 16a has two lateral and opposite connection rods 16aa (see also FIG. 4). Via bearing components 16ak which are fastened in particular in a positionally fixed manner to the support device 15a, lower ends of the connection rods 16aa of the connecting frame 16a are mounted on the support device 15a in an articulated manner via a pair of transverse axes Y2. In this case, the third transverse axes Y2 are oriented substantially horizontally, in the longitudinal direction X of the counterweight carriage 2 and in the transverse direction Y. The connection rods 16aa are mounted on the support device 15a via the third transverse axes Y2 so as to be slightly angularly movable by up to 5°, preferably only 2°, in the longitudinal direction X and in the opposite direction thereto. The angular mobility is delimited in both directions in each case via a stop 16ah which is supported on the support device 15a when the respectively maximum angle is reached. The angular mobility or the reaching of the respectively maximum angle can be used via angle transmitters or limit switches additionally in conjunction with the controller of the counterweight carriage 2 via the crane controller 19 of the crawler crane 1 to send warning signals or shutdown signals to the crane controller 19 if the travel/rotational movements of the crawler crane 1 do not take place to the greatest possible extent in synchronism with the travel movements of the counterweight carriage 2. In this case, the angle transmitters or limit switches can be arranged in the region of both third transverse axes Y2 or only on one third transverse axis Y2 because the two third transverse axes Y2 move synchronously because the connection rods 16aa are fixedly connected to one another via the outer frame 16ab. At an upper end of the two connection rods 16aa, the additional guying arrangements 14 are each bolted in an articulated manner via further first transverse axes Y1.1. In this case, the first transverse axes Y1.1 are oriented in parallel with the third transverse axes Y2 and in the longitudinal direction of the counterweight carriage 2 and in the transverse direction Y. It can also be seen that a rear end 16ba of the coupling frame 16b is suspended in the connecting frame 16a via a further second transverse axis Y1.2, which is concealed in FIG. 3 (see FIG. 4), in a swinging manner via a pivoting element 16ac (see FIG. 4), of which only connection struts 16ad are visible in this case. The coupling frame 16b is detachably connected to the connecting frames 16a via these connection struts 16ad. For this purpose, a bolt connection 16c is provided at the end of the connection struts 16ad opposite the connecting frame 16a. Furthermore, this pivoting element 16ac can also be pivoted about the first axis of rotation Z1 within the connecting frame 16a.

FIG. 4 illustrates in perspective an enlargement of a section of FIG. 2 from the region of the connecting frame 16a of the coupling unit 16. The structure of the connecting frame 16a is explained hereinafter on the basis of this enlargement of a section. It can be seen that the outer frame 16ab which is u-shaped and open at the top is arranged between the two connection rods 16aa and is rigidly fastened to these two connection rods 16aa. This open outer frame 16ab is closed at the top by a transverse rod 16ae to provide an upper bearing point for a bearing element 16af which can be pivoted about the vertical first axis of rotation Z1. The open outer frame 16ab with the transverse rod 16ae forms a rectangle with a rectangular opening in which the bearing element 16af is arranged. A lower bearing point for the bearing element 16af is provided by the outer frame 16ab. Overall, the rectangular bearing element 16af can thus be pivoted about the first axis of rotation Z1 within the outer frame 16ab. In a lateral upper region of the bearing element 16af, the rectangular pivoting element 16ac is suspended from the bearing element 16af on both sides via a horizontal second transverse axis Y1.2. The two second transverse axes Y1.2 are advantageously aligned with the two outer first transverse axes Y1.1. The pivoting element 16ac has a central round opening 16ag for low-clearance reception of the rear end 16ba of the coupling frame 16b which is designed preferably as a round tube. As described above, the coupling frame 16b is detachably fastened via the connection struts 16ad which are held on the pivoting element 16ac. During installation of the additional counterweight 15, the coupling frame 16b is inserted with its rear end 16ba into the opening 16ag of the pivoting element 16ac and then connected to the connection struts 16ad via the bolt connection 16c.

Overall, the connecting frame 16a which is designed as a universal joint frame thus provides the degree of rotational freedom (first axis of rotation Z1) and also the degree of translational freedom in the X direction, which is achieved via the two degrees of rotational freedom in the form of the second transverse axis Y1.2 and the third transverse axis Y2. In addition, tipping over can be prevented by the two degrees of rotational freedom in the form of the second transverse axis Y1.2 and the third transverse axis Y2 about the Y transverse axis if the support device 15a with the additional counterweight plates 15b rests on the counterweight carriage 2. The connecting frame 16a is designed in such a way that force can be transmitted in the longitudinal direction of the superstructure 5. This refers to the restoring forces of the additional counterweight 15 which result from the inclined position of the additional guying arrangement 14. Any forces arising from the counterweight carriage 2 not moving completely synchronously with the crawler crane 1 are dissipated by the degrees of freedom.

This allows the additional counterweight 15 to be positioned on a radius in relation to the axis of rotation Z of the superstructure 5 which deviates from the radius of a tip of the counter jib head 10a of the counter jib 10. The connecting frame 16a also enables direct force transmission in the transverse direction of the superstructure 5.

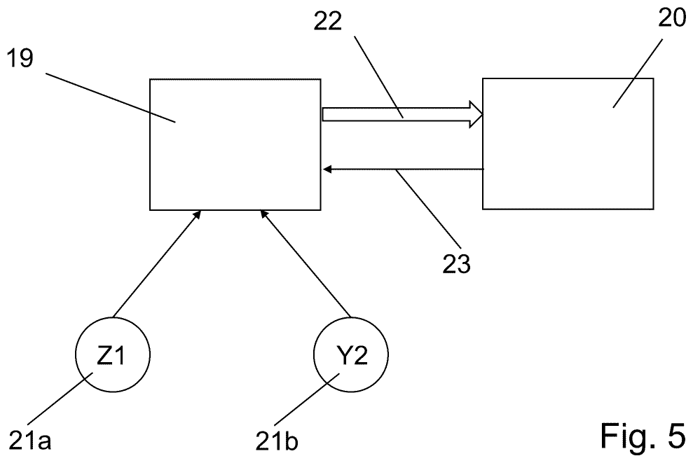

FIG. 5 shows a schematic overview for controlling a counterweight carriage controller 20 of the counterweight carriage 2 via a crane controller 19 of the crawler crane 1. In other words, a counterweight carriage 2, in particular a series-produced heavy-duty transport vehicle, is connected, as well as controlled and monitored, by means of connection of the counterweight carriage controller 20 of the counterweight carriage 2 to the crane controller 19 of the crawler crane 1 via a corresponding interface. The movements of crawler crane 1 are thus initiated by the crane operator, and crane controller 19 of the crawler crane 1 specifies the movements to the counterweight carriage controller 20 of the counterweight carriage 2. The counterweight carriage controller 20 is thus dependent upon the crane controller 19. The crane controller 19 specifies the speed, direction of travel and steering direction to the counterweight carriage controller 20 of the counterweight carriage 2. In order to receive indirect feedback with respect to the travel movements of the counterweight carriage 2, at least a first sensor 21a and a second sensor 21b are arranged on connecting frame 16a. The first sensor 21a detects rotations about the first axis of rotation Z1 and the second sensor 21b detects rotations about the third transverse axis Y2. The two sensors 21a, 21b are each designed as angle sensors. The crane controller 19 of the crawler crane 1 also receives feedback with respect to the actual values of the counterweight carriage 2 from the counterweight carriage controller 20 of the counterweight carriage 2 as required.

The first sensor 21a is used for detecting an angle of rotation of the counterweight carriage 2 relative to the superstructure 5 about the vertical first axis of rotation Z1. The second sensor 21b is used for detecting a movement of the counterweight carriage 2 and the additional counterweight 15 resting thereon, with the length of the coupling unit 16 being invariable relative to the superstructure 5 and in the longitudinal direction of the superstructure 5. The crane controller 19 evaluates the signals from the sensors 21a and 21b in order to verify and correct the control of the counterweight carriage 2, wherein the signals describe a distance between the crawler crane 1 and the counterweight carriage 2 and a direction of travel of the crawler crane 1 with respect to a direction of travel of the counterweight carriage 2. The speed and steering direction of the counterweight carriage 2 are corrected by the crane controller 19 on the basis of the detected deviations from the signals from the sensors 21a and 21b. In this case, provision is made that the support device 15a, and thus the additional counterweight 15, remains in a horizontal plane, i.e. flat on the transport platform 2a, 2a′, and cannot tip over.

The above-described verification and correction is effected by virtue of the fact that the connecting frame 16a, as a suitable mechanical connection, permits specific tolerance ranges for the translational and rotational movements (third transverse axis Y2, second transverse axis Y1.2, first axis of rotation Z1) which are detected via the sensors 21a and 21b. On the basis of the signals from the sensors 21a and 21b, the crane controller 19 then determines deviations of the counterweight carriage 2 from an ideal position and sends correction signals to the counterweight carriage controller 20 of the counterweight carriage 2. The possible movements of the third transverse axis Y2, the second transverse axis Y1.2 and the first axis of rotation Z1 are to be kept to a minimum. A corresponding tolerance range is to be selected such that on the one hand deviations can be reliably recognised and on the other hand measures can be taken in good time to reliably prevent mechanical collisions and overloading of the components. If a specified tolerance range of the signals from the sensors 21a and 21b is exceeded, the crawler crane 1 and the counterweight carriage 2 are stopped for safety reasons. The counterweight carriage controller 20 is also connected to the crane controller 19 via a return line 23. In the event of a malfunction on counterweight carriage 2, this is reported to crane controller 19 via the return line 23 and the function of the crawler crane 1 is restricted or switched off accordingly.

The basic movements of the crawler crane 1 in combination with the counterweight carriage 2 consist on the one hand of the circular travel of the counterweight carriage 2 together with a rotation of the superstructure 5 and on the other hand of towing travel in which the counterweight carriage 2 follows the crawler crane 1. In order to rotate the superstructure 5, a rotary drive of the superstructure 5 is switched to a slightly braked or complete idle mode and the superstructure is rotated via the counterweight carriage 2, of which the wheels 2c are steered in circular travel. In this case, the counterweight carriage 2 takes on the driving task. The counterweight carriage 2 is controlled via the crane controller 19, as described above. For towing travel, the driven counterweight carriage 2 follows the crawler crane 1 travelling in front, wherein the counterweight carriage 2 and the crawler crane 1 move synchronously to the greatest possible extent. During rotation and also during towing travel, the additional counterweight 15 with its transverse direction, i.e. the counterweight carriage 2 with its longitudinal direction, is oriented orthogonally to the longitudinal direction of the superstructure 5. Only the steering direction of the wheels 2c of the counterweight carriage 2 is different. During rotation on a circular path, the wheels 2c are oriented substantially transversely to the crawler tracks 4a, 4b, and during towing travel, said wheels are oriented in the direction of the crawler tracks 4a, 4b.

In the above description of an exemplified embodiment, at least a first sensor 21a and a second sensor 21b are described as being sufficient to control and to monitor the counterweight carriage 2. It goes without saying that additional sensors are provided and their signals are also processed by the crane controller 19. For example, the two sensors 21a and 21b which are present can be designed redundantly, and a rotational movement of the first and second transverse axes Y1.1, Y1.2 and/or a length of a telescopic coupling frame 16b can be detected by means of additional sensors.

FIG. 6 shows a side view of a further inventive arrangement consisting of an alternative crawler crane 1 and a counterweight carriage 2, which corresponds substantially to the arrangement shown in FIG. 1. Accordingly, reference is thus made to the description in relation to FIG. 1. One difference between the two crawler cranes 1 shown in FIGS. 1 and 6 is present in the guying arrangement of the counter jib 10. In FIG. 6, it is not the counter jib guying arrangement 11 which is designed as luffing cabling but rather the guying support-guying arrangement 13 which is designed as hoist-type luffing cabling. The counter jib guying arrangement 11 consists in each case of cables, chains or rods, as well as portions thereof arranged one behind the other, or any combinations thereof. In addition, hoist-type tensioning devices can also be provided at this location.

In the above description of an exemplified embodiment, the counterweight carriage 2 has been described as a group of standard heavy-duty transport vehicles. It goes without saying that conventional crawler crane counterweight carriages can also be used as counterweight carriages 2.

It is also feasible to use the counterweight carriage 2 or the heavy-duty transport vehicle(s) as part of the additional counterweight 15, i.e. to raise them as well. For this purpose, the additional counterweight 15 or the support device 15a would then have to be connected to the counterweight carriage 2 in the vertical direction.

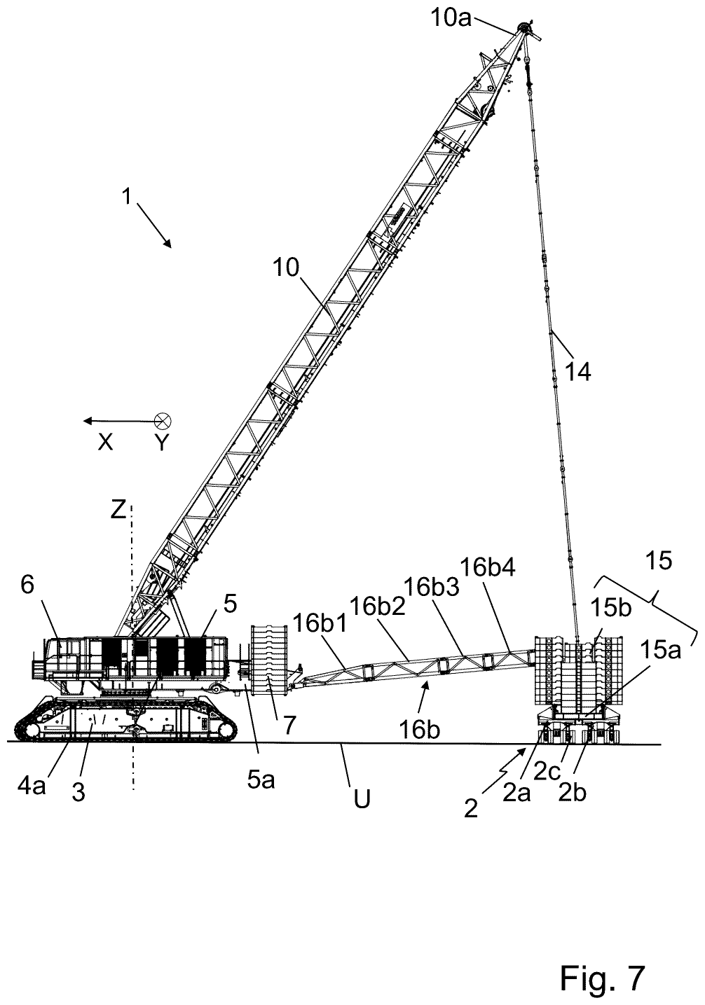

FIG. 7 shows a side view of an inventive arrangement of a second embodiment consisting of a crawler crane 1 and a counterweight carriage 1. This is the crawler crane 1 shown in FIG. 1, wherein for the sake of clarity the jib 8, the luffing cabling 9, the counter jib guying arrangement 11, the guying support 12, the lifting cable 17 and the hook 18 are not illustrated.

In a conventional manner, the crawler crane 1t has the lower carriage 3 having the two right and left crawler tracks 4a, 4b which are arranged in parallel with one another and can be moved on the ground U. The crawler tracks 4a, 4b extend in parallel with the substantially horizontally extending longitudinal direction X of the lower carriage 3 and are spaced apart from one another in the transverse direction Y which extends orthogonally to the longitudinal direction X and substantially horizontally. The longitudinal direction X of the lower carriage 3 corresponds to the straight-ahead direction of travel of the lower carriage 3 or the crawler crane 1. Arranged on the lower carriage 3 is the superstructure 5 which can be pivoted relative to the lower carriage 3 about the vertically extending axis of rotation Z. The superstructure 5 is provided with the driver's cabin 6 at the front and with the counterweight 7 at the rear end. The counter jib 10 is fastened to the superstructure 5 about the horizontal axis extending in parallel with the transverse direction of the superstructure 5 and is fastened in a conventional manner starting from the counter jib head 10a via the counter jib guying arrangement 11, not illustrated here, to the guying support 12, not illustrated.

The additional counterweight 15 is suspended from the counter jib head 10a of the counter jib 10 via the additional guying arrangement 14 and is supported via the coupling unit 16 at the rear end 5a of the superstructure 5. For this purpose, the coupling unit 16 is fastened on the one hand to the superstructure 5 and on the other hand to the additional counterweight 15.

In the unloaded state of the crawler crane 1 as illustrated in FIG. 7, the additional counterweight 15 is placed on the movable counterweight carriage 2 in order to be able to move or rotate the crawler crane 1. In FIG. 7, the counterweight carriage 2 extends with its longitudinal extension substantially in the transverse direction Y so that it is oriented orthogonally to the straight-ahead direction of travel of the lower carriage 3. The additional counterweight 15 is connected to the superstructure 5 via the coupling unit 16.

In this embodiment, the additional counterweight 15 also consists substantially of the support device 15a and the additional counterweight plates 15b which are stacked on the support device 15a. The counterweight carriage 2 is also designed in this case as a standard heavy-duty transport vehicle.

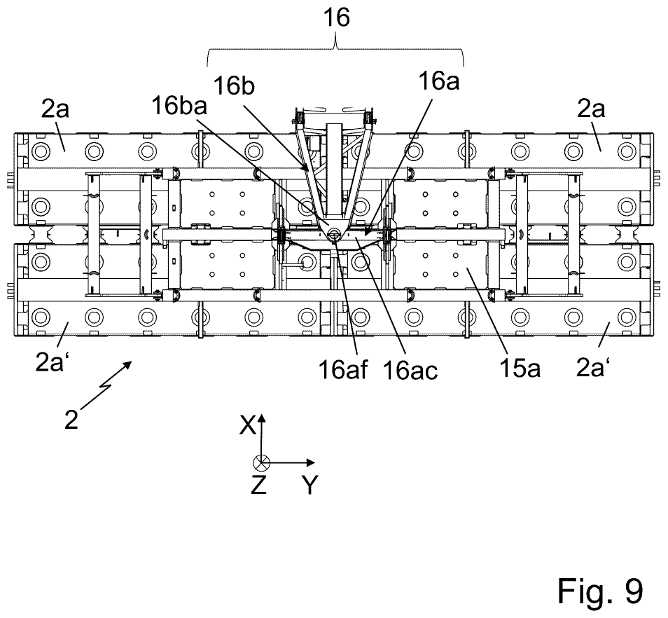

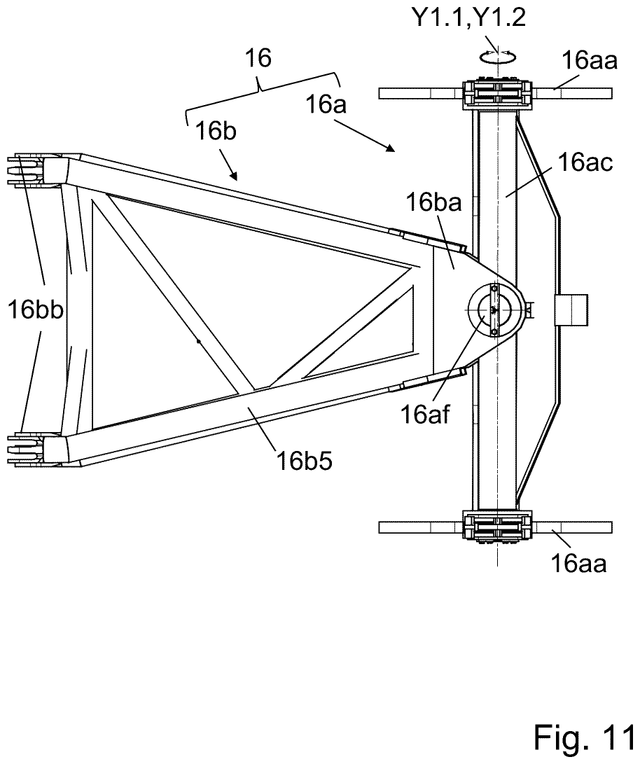

In this second embodiment, the coupling unit 16 comprises a coupling frame 16b in addition to a connecting frame 16a. The coupling frame 16b is designed in this case as a lattice mast frame and has a large number of struts (not designated), in particular longitudinal struts, transverse struts and/or diagonal struts, which are connected to one another in the manner of a latticework. The coupling frame 16b has a plurality of coupling elements 16b1-16b5 which can be arranged alongside one another. At least one coupling element 16b1 is designed to connect the coupling frame 16b to the superstructure 5 in an articulated manner. At least one further and last coupling element 16b5 (see FIG. 11) is designed to connect the coupling frame 16b to the connecting frame 16a. The coupling elements 16b1-16b5 have different lengths but can also be the same length. The coupling elements 16b1-16b5 can be selected and arranged alongside one another in dependence upon a size of the crawler crane, a bearing load of the crawler crane, a length of the jib 8 and/or counter jib 10, a required additional counterweight 15 and further factors, in particular those determining the center of gravity of the crane 1, in order to form a coupling frame 16b of variable length. For this purpose, the coupling elements 16b1-16b5 can be detachably fastened to one another by fastening means 16bb (see FIG. 9), such as screws, bolts or pins. In a mounted state, the coupling frame 16b is attached to the crawler crane 1 and then preferably remains unchanged in relation to its length. The length of the coupling frame 16b which is then set determines the radius of the additional counterweight 15 in relation to the axis of rotation Z of the superstructure 5. The length of the coupling frame 16b can thus be provided such that the counterweight moment generated by the additional counterweight 15 is effective and/or optimised in relation to the crawler crane 1.

In principle, it is also possible to provide a telescopic coupling element (not shown) which can be installed in the lattice mast structure of this coupling frame 16b as required in order to be able to variably adapt the length of the coupling frame 16b, or which replaces the lattice mast structure.

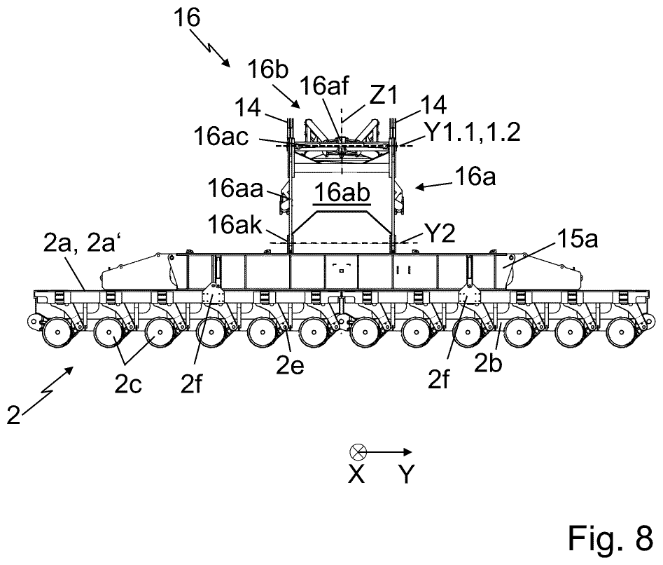

FIG. 8 shows a side view of the counterweight carriage 2 and FIG. 9 shows a plan view of the counterweight carriage 2, each showing that of FIG. 7.

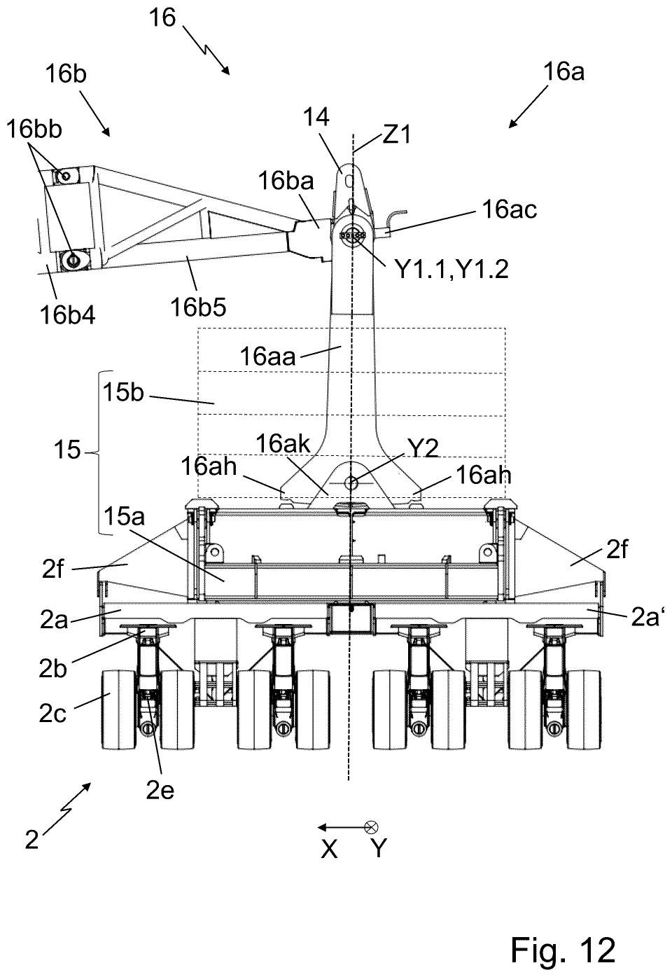

The plan view in FIG. 9 shows that the counterweight carriage 2 consists of several heavy-duty transport vehicles which are coupled one next to the other and one behind the other. For clarification, the transport platforms 2a located at the bottom of the plane of the drawing are designated by 2a′ in FIG. 9. The arrangement of two heavy-duty transport vehicles positioned one next to the other can also be seen in FIG. 12. In relation to a longitudinal direction of the heavy-duty transport vehicles, they are arranged in parallel with one another and with their transport platforms 2a, 2a′ adjacent to one another.

The support device 15a which is part of the additional counterweight 15 is placed on the transport platforms 2a, 2a′ of the counterweight carriage 2. The additional counterweight plates 15b, which are stacked in a conventional manner on the support device 15a and are likewise part of the additional counterweight 15, are not illustrated.

The support device 15a is designed in the form of a pallet or frame and supports, in particular in the center, the connecting frame 16a which is part of the coupling unit 16. The connecting frame 16a has the task of connecting the coupling frame 16b of the coupling unit 16 in an articulated manner to the additional counterweight 15, in particular to the support device 15a. For this purpose, the connecting frame 16a has the second transverse axis Y1.2, the third transverse axis Y2 which is substantially parallel thereto and the substantially vertical first axis of rotation Z1. In addition, the connecting frame 16a serves, in particular at its lateral upper end, to couple the additional guying arrangements 14 in an articulated manner. In order to couple the additional guying arrangements 14 in an articulated manner, the connecting frame 16a has the first transverse axes Y1.1 which are collinear to the second transverse axis Y1.2. The additional guying arrangements 14 are mounted on the connecting frame 16a so as to be rotatable about the second transverse axes Y1.2 in each case and extend in each case from the counter jib head 10a to the connecting frame 16a, in particular to the connection rods 16aa of the connecting frame 16a.

The counterweight carriage 2 is designed as a standard and self-driving heavy-duty transport vehicle. Such heavy-duty transport vehicles have a dedicated drive and control unit which is not illustrated in this case (see FIG. 2 in this respect). Therefore, they can be moved and controlled independently. The counterweight carriage 2 consists substantially of the transport platform 2a, 2a′ which rests on the running gear unit frame 2b, on which a large number of wheels 2c are mounted on center pivot plates 2e so as to be pivotable about a vertical axis. Two center pivot plates 2e are provided per axle. The center pivot plates 2e with the wheels 2c can each be steered individually and the wheels 2c on at least a part of the center pivot plates 2e are driven individually. As a result, the counterweight carriage 2 can be moved in any movement directions on the ground U.

FIG. 8 shows a side view of the counterweight carriage 2. The counterweight carriage 2 moves on a circular path. The circular path is determined by the distance between the wheels 2c and the pivot axis of the superstructure 5. However, the steering angle of the wheels 2c is so small that it is not noticeable in the side view. Such circular travel is effected when the crawler crane 1 is rotated. The counterweight carriage 2 is thus oriented with its longitudinal direction at a right angle to the longitudinal direction of the superstructure 5. It is controlled via its drive and control module 2d which receives corresponding control signals from a crane controller 19 of the crawler crane 1.

The counterweight carriage 2 illustrated in FIGS. 8 and 9 also has a total of four standard heavy-duty transport vehicles, which are coupled to one another mechanically and in terms of control technology, in adaptation to the dimensions and the weight of the additional counterweight 15 which is to be transported. The heavy-duty transport vehicles can be moved together in a master and slave mode. In a similar manner to the counterweight carriage 2 in FIG. 2, each of the four heavy-duty transport vehicles has the six axles arranged one behind the other as seen in the longitudinal direction of the counterweight carriage 2, wherein each axle is allocated the two center pivot plates, on which the two wheels 2c are mounted in each case. These wheels 2c can also be steered individually via the center pivot plates, wherein only every second axle is driven. The number of driven axles can be adapted to the load which is to be transported, or to other boundary conditions.

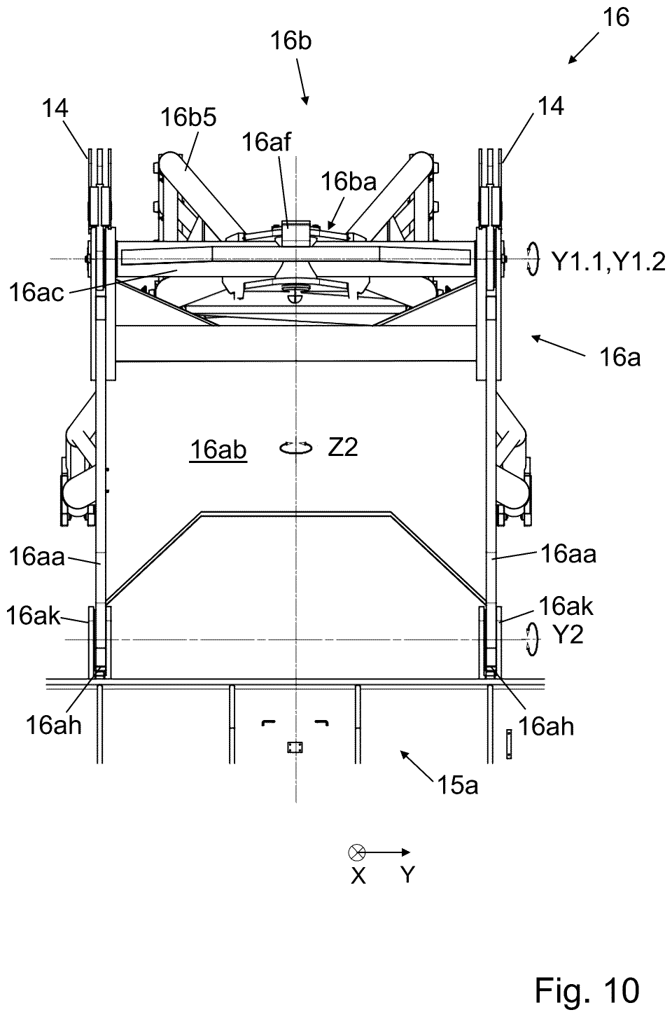

FIG. 10 shows an enlargement of a section of FIG. 8 from the region of the connecting frame 16a of the coupling unit 16, and FIG. 11 shows a plan view of a section of the coupling unit 16. The structure of the connecting frame 16a is explained hereinafter on the basis of these figures.

The connecting frame 16a has the two connection rods 16aa which are spaced apart from one another in the longitudinal direction X of the counterweight carriage 15. The connection rods 16aa of the connecting frame 16a are mounted on the bearing components 16ak—which are fastened in a positionally fixed manner to the support device 15a—in each case in an articulated manner, in particular so as to be rotatable about a third transverse axis Y2 in each case. The third transverse axes Y2 are oriented substantially horizontally in the longitudinal direction X of the counterweight carriage 2. The longitudinal direction X of the counterweight carriage 2 extends substantially in the transverse direction Y of the crawler crane 1. The connection rods 16aa are fixedly connected to one another via the outer frame 16ab and are thus, in particular synchronously with respect to one another, in particular slightly angularly movable relative to the support device 15a, about the second transverse axes Y1.2, in particular in each case about one of the bearing components 16ak. Therefore, the connection rods 16aa are pivotable in the longitudinal direction X of the crawler crane 1 and in the opposite direction thereto, in particular by a maximum of 5°, preferably only by 2°. The angular mobility is delimited in both directions in each case via a stop 16ah which is supported on the support device 15a when the respectively maximum angle is reached. The angular mobility or the reaching of the respectively maximum angle can be used via angle transmitters or limit switches in conjunction with the controller of the counterweight carriage 2 by the crane controller 19 of the crawler crane 1 in order to send warning signals or shutdown signals to the crane controller 19 if the travel movements and/or rotational movements of the crawler crane 1 do not take place to the greatest possible extent in synchronism with those of the counterweight carriage 2. In this case, the angle transmitters or limit switches can be arranged in the region of both third transverse axes Y2 or, since the two third transverse axes Y2 move synchronously, only on one third transverse axis Y2.

At an upper end of the two connection rods 16aa, the two additional guying arrangements 14 are bolted in an articulated manner via a further first transverse axis Y1.1 in each case. In this case, the first transverse axes Y1.1 are oriented in parallel with the third transverse axes Y2 and in the longitudinal direction X of the counterweight carriage 2.

The outer frame 16ab is arranged between the two connection rods 16aa and is rigidly fastened thereto. In this embodiment of the connecting frame 16a, a pivoting element 16ac extends between the two connection rods 16aa and can be pivoted about the second transverse axis Y1.2. In this case, the pivoting element 16ac is arranged above the outer frame 16ab. The arrangement of the pivoting element 16ac above the outer frame 16ab means that it is spaced further apart from the support device 15a than the outer frame 16ab. In principle, however, it is also possible to arrange the pivoting element 16ac in the region of or below the outer frame 16ab. At the pivoting element 16ac, the coupling frame 16b is mounted on a bearing element 16af. Therefore, the coupling frame 16b can be pivoted with the pivoting element 16ac about the second transverse axis Y1.2. In addition, the bearing element 16af is provided so as to be rotatable about the vertical first axis of rotation Z1. As a result, the coupling frame 16b can be about the vertical first axis of rotation Z1. During installation of the additional counterweight 15, the coupling frame 16b is detachably connected to the bearing element 16af at its rear end 16ba, e.g. via a bolt connection.

In one possible embodiment of the bearing element 16af, a bolt-tab connection is provided. The rear end 16ba of the coupling frame 16b has an upper and a lower tab with mutually aligned holes for a connecting bolt. The connecting bolt is additionally guided through a sleeve in the center of the pivoting element 16ac. A plain bearing for the connecting bolt is provided in the sleeve. The connecting bolt is connected to the upper tab of the rear end 16ba of the coupling frame 16b for conjoint rotation therewith and is inserted in a conventional manner according to a type of bolt-tab connection through the upper tab, the sleeve and the lower tab. Overall, the rear end 16ba of the coupling frame 16b can thus be pivoted with the connecting bolt relative to the pivoting element 16ac with the sleeve.

Overall, this connecting frame 16a also provides the degree of rotational freedom via the first vertical axis of rotation Z1 and the degree of translational freedom in the X direction, which is achieved via the two degrees of rotational freedom in the form of the, in particular horizontally oriented, second transverse axis Y1.2 and third transverse axis Y2. The connecting frame 16a is designed in such a way that force can be transmitted in the longitudinal direction X of the superstructure 5 and in the opposite direction thereto. This refers to the restoring forces of the additional counterweight 15 which result from the inclined position of the additional guying arrangement 14. Any forces arising from the counterweight carriage 2 not moving completely synchronously with the crawler crane 1 are dissipated by the degrees of freedom.

This allows the additional counterweight 15 to be positioned on a radius in relation to the axis of rotation Z of the superstructure 5, which deviates from the radius of a tip of the counter jib head 10a of the counter jib 10. The connecting frame 16a also enables direct force transmission in the transverse direction Y of the superstructure 5.

FIG. 12 shows an enlarged front view of the counterweight carriage 2 of FIG. 7. The stacked additional counterweight plates 15b are indicated only schematically as dotted lines on the support device 15a. It is also apparent from the front view shown in FIG. 12 that the counterweight carriage 2 is formed from two heavy-duty transport vehicles coupled mechanically and in terms of control technology next to one another in the region of the two transport platforms 2a, 2a′. For clarification, the transport platforms 2a located on the right in the plane of the drawing are also designated in this FIG. by 2a′. The arrangement of two heavy-duty transport vehicles which are coupled mechanically and in terms of control technology one behind the other can be seen in FIGS. 8 and 9. In relation to a longitudinal direction of the two heavy-duty transport vehicles, the heavy-duty transport vehicles are arranged in parallel with one another and with their transport platforms 2a, 2a′ adjacent to one another. The support device 15a thus rests simultaneously on four transport platforms 2a, 2a′ of the coupled heavy-duty transport vehicles. The support device 15a is not fastened, in particular not mechanically, to the two transport platforms 2a, 2a′, but instead rests only with its dead weight on the transport platforms 2a, 2a′. In order to facilitate positioning of the support device 15a of the additional counterweight 15 on the transport platforms 2a, 2a′ and to prevent the additional counterweight 15 from slipping in the horizontal transverse direction of the counterweight carriage 2 on the transport platforms 2a, 2a′, which corresponds to the longitudinal direction X of the crawler crane 1, upwardly protruding guides 2f are arranged on the transport platforms 2a, 2a′. Further guides 2f can also be provided which prevent the additional counterweight 15 from slipping in the horizontal longitudinal direction X of the counterweight carriage 2 on the transport platforms 2a, 2a′. In this embodiment, the additional counterweight 15 is bolted to the transport platforms 2a, 2a′ or their guides 2f and therefore it is additionally possible to use at least some of the weight of the transport platforms 2a, 2a′ as an additional counterweight 15. The additional counterweight 15 is then detachably coupled to the transport platforms 2a, 2a′. Alternatively, the additional counterweight 15 can stand on the transport platforms 2a, 2a in an only laterally guided manner without a coupling.

The counterweight carriage 2 of this second embodiment (see FIGS. 7 to 13) is controlled in a manner analogous to that described above (see FIGS. 1 to 5).

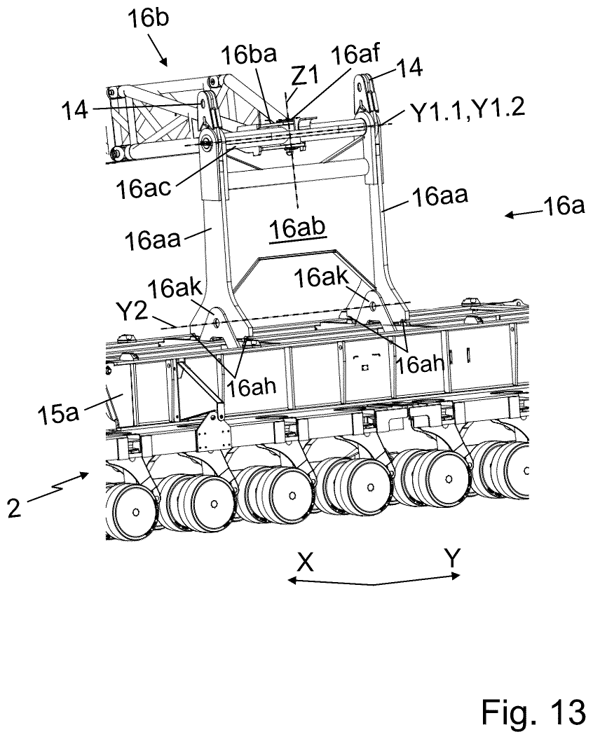

FIG. 13 shows a perspective view of a section of the counterweight carriage 2 of FIG. 8. The articulated fastening of the connecting frame 16a to the support device 15a for the additional counterweight plates 15b via the bearing components 16ak can be seen, in particular approximately in the center of the counterweight carriage 2. Furthermore, FIG. 13 shows the fixed connection of the connection rods 16aa to one another via the outer frame 16ab. Also apparent is a distance (not designated) between the stops 16ah of the connection rods 16aa and the support device 15a of the additional counterweight 15, which enables the angular mobility of the connection rods 16aa with respect to the support device 15a in the transverse direction Y of the counterweight carriage 2 and in the opposite direction thereto about the third transverse axes Y2. It is also possible to see the pivoting element 16ac which is arranged above the outer frame 16ab, i.e. spaced further apart from the support device 15a than the outer frame 16ab, and extends between the connection rods 16aa. The pivoting element 16ac extends in the direction of the second transverse axis Y1.2 and is mounted on the connection rods 16aa so as to be rotatable about said transverse axis. Finally, FIG. 13 shows that the rear end 16ba of the coupling frame 16b is fastened to the pivoting element 16ac via the bearing element 16af. The rear end 16ba of the coupling frame 16b is rotatable with the bearing element 16af about the first axis of rotation Z1. Therefore, when the coupling frame 16b is pivoted about the first axis of rotation Z1, only the bearing element 16af within the connecting frame 16a is rotated. For this purpose, the coupling frame 16b is fastened, at its precisely one bearing position (not designated) located at the rear end 16ba, to the bearing element 16af which is arranged in the center of the pivoting element 16ab.

The coupling frame 16b of both embodiments described (FIGS. 1 and 7) absorbs forces both in the longitudinal direction X of the crawler crane 1 and also in the direction opposite to the longitudinal direction X of the crawler crane 1. This permits an additional guying arrangement 14 which does not extend perpendicularly so that the counterweight carriage 2 does not have to be arranged perpendicularly below the counter jib head 10a, but instead can be spaced further apart from the crawler crane 1. Restoring forces of the additional counterweight 15 which result from the inclined position of the additional guying arrangement 14 can be dissipated via the coupling frame 16b. When the counterweight carriage 2 is located a greater distance away from the crawler crane 1, a smaller additional counterweight 15 is required compared to the perpendicular arrangement of the counterweight carriage 2 below the counter jib head 10a, or crawler cranes 1 with a higher maximum bearing load can be moved with the same additional counterweight 15.

It is understood that in this case the terms ‘vertical’ and ‘horizontal’ each refer to a crawler crane 1 or counterweight carriage 2 placed on flat, horizontally extending ground.

Changes and modifications in the specifically described embodiments can be carried out without departing from the principles of the present invention which is intended to be limited only by the scope of the appended claims, as interpreted according to the principles of patent law including the doctrine of equivalents.

1. An arrangement of a crawler crane and a counterweight carriage for an additional counterweight;
wherein the additional counterweight is connected to a superstructure of the crawler crane via a coupling unit;
wherein the coupling unit comprises a connecting frame and a coupling frame, and wherein the connecting frame is fastened on a support device of the additional counterweight and the coupling frame is fastened at one end to the superstructure and is fastened at another rear end to the connecting frame; and
wherein the connecting frame has a substantially vertical first axis of rotation about which the coupling frame is pivotable.

2. The arrangement as claimed in claim 1, wherein the coupling frame is mounted on the connecting frame so as to be rotatable about the first axis of rotation.

3. The arrangement as claimed in claim 2, wherein the coupling frame is mounted on the connecting frame so as to be pivotable about a second transverse axis.

4. The arrangement as claimed in claim 3, wherein the connecting frame has two mutually opposite connection rods which delimit the connecting frame laterally, wherein an outer frame is arranged between the two connection rods and is rigidly fastened thereto.

5. The arrangement as claimed in claim 4, wherein the connection rods are angularly movable relative to the support device in a synchronous manner with respect to one another in each case about a third transverse axis.

6. The arrangement as claimed in claim 4, wherein the connecting frame comprises bearing components which are fastened to the support device in a positionally fixed manner, and wherein each of the connection rods is mounted in each case on one of the bearing components so as to be pivotable about the third transverse axis.

7. The arrangement as claimed in claim 4, wherein the angular mobility of the connection rods is delimited in both directions in each case via a stop that is supported on the support device when the respectively maximum angle is reached.

8. The arrangement as claimed in claim 4, wherein a pivoting element extends between the two connection rods and is mounted so as to be pivotable about the second transverse axis, and wherein the coupling frame is mounted on the pivoting element.

9. The arrangement as claimed in claim 8, wherein the pivoting element is arranged within or above the outer frame, wherein a bearing element is arranged on or in the pivoting element and is provided so as to be rotatable about the vertical first axis of rotation, and wherein the coupling frame is mounted on the bearing element.

10. The arrangement as claimed in claim 4, wherein additional guying arrangements are bolted in an articulated manner to the connecting frame in each case via the first transverse axes at an upper end of the two connection rods, and wherein the additional guying arrangements extend in each case from a counter jib head of a counter jib of the crane to the connection rods.

11. The arrangement as claimed in claim 8, wherein a rear end of the coupling frame is suspended via the second transverse axis in a swinging manner via the pivoting element in the connecting frame, and wherein the pivoting element can be pivoted about the first axis of rotation within the connecting frame.

12. The arrangement as claimed in claim 5, wherein the connecting frame is fastened on the one hand to the coupling frame and on the other hand to the support device with at least some degree of translational freedom and some degree of rotational freedom.

13. The arrangement as claimed in claim 12, wherein at least a first sensor and a second sensor are arranged on the connecting frame, and wherein the first sensor ascertains rotations about the first axis of rotation and the second sensor ascertains rotations about the third transverse axis.

14. The arrangement as claimed in claim 13, wherein the first sensor is used for detecting an angle of rotation of the counterweight carriage relative to the superstructure about the vertical first axis of rotation, and wherein the second sensor is used for detecting a movement of the counterweight carriage and the additional counterweight resting thereon, with the length of coupling unit being invariable relative to the superstructure and in the longitudinal direction of the superstructure.

15. The arrangement as claimed in claim 1, wherein the coupling frame is variable in length, and wherein the crawler crane has a counter jib from which the additional counterweight is suspended.

16. The arrangement as claimed in claim 1, wherein a crane controller of the crawler crane controls the counterweight carriage via its counterweight carriage controller.

17. The arrangement as claimed in claim 16, wherein the crane controller evaluates signals from a first sensor and a second sensor for controlling the counterweight carriage, wherein the first sensor and the second sensor are arranged on the connecting frame, and wherein the first sensor ascertains rotations about the first axis of rotation and the second sensor ascertains rotations about a transverse axis.

18. The arrangement as claimed in claim 1, wherein the counterweight carriage comprises at least one of (i) a dedicated drive, a dedicated steering system and a dedicated counterweight carriage controller, and (ii) at least one heavy-duty transport vehicle.

19. A method for operating an arrangement comprising the crawler crane and the counterweight carriage for the additional counterweight as claimed in claim 1, wherein the crawler crane has a crane controller and the counterweight carriage has a counterweight carriage controller, and wherein the counterweight carriage is controlled by the crane controller of the crawler crane via its counterweight carriage controller, said method comprising:
evaluating signals from a first sensor and a second sensor by the crane controller in order to verify and correct the control of the counterweight carriage, wherein the signals describe a distance between the crawler crane and the counterweight carriage and a direction of travel of the crawler crane with respect to a direction of travel of the counterweight carriage.

20. The method as claimed in claim 19, wherein the first sensor is used for detecting an angle of rotation of the counterweight carriage relative to the superstructure about the vertical first axis of rotation, and wherein the second sensor is used for detecting a movement of the counterweight carriage with the additional counterweight resting thereon, with the length of the coupling unit being invariable relative to the superstructure and in the longitudinal direction of the superstructure.
